(19) United States
(12) Patent Application Publication
(10) Pub. No.: US 2019/0210470 A1
(43) Pub. Date: Jul. 11, 2019

(54) PLATFORM FOR AN ELECTRIC VEHICLE

(71) Applicant: Byton Limited, Hong Kong (HK)

(72) Inventors: Paul Thomas, Pleasanton, CA (US); Antonio Maresca, Leamington Spa (GB); Kevin Konecky, Trabuco Canyon, CA (US); Dirk Abendroth, Mountain View, CA (US); Wei Zhou, Santa Clara, CA (US)

(21) Appl. No.: 15/863,851

(22) Filed: Jan. 5, 2018

(51) Int. Cl. B60L 11/18; B62D 21/10; B62D 21/14; B60K 1/04

(52) U.S. Cl. CPC B60L 11/1877; B62D 21/10; B60L 11/1879; B62D 21/11; B60K 1/04; B60K 2001/0438; B62D 21/14

(57) ABSTRACT

Embodiments of an apparatus include a front section of a vehicle platform for an electric vehicle and a rear section of a vehicle platform for the electric vehicle. A panel joins a rear edge of the front section to the front edge of the rear section, and the length of the panel can be varied to change the wheelbase of the vehicle platform. A battery pack has a plurality of battery modules therein and can be coupled to a lower part the vehicle platform. The length of the battery pack and the arrangement of the battery modules inside the battery pack depend on the wheelbase of the vehicle platform.

### TECHNICAL FIELD

The disclosed embodiments relate generally to vehicles, and in particular, but not exclusively, to a platform for an electric vehicle.

### BACKGROUND

To satisfy a large cross-section of customers, car manufacturers usually offer several different models with different styles, sizes, and capabilities. Sedans, coupes, hatchbacks, large and small sport utility vehicles (SUVs), and trucks are all examples of potential offerings. To save manufacturing costs and reduce manufacturing complexity it is desirable for a manufacturer to use as many common parts as possible across their line of offerings; the more parts can be re-used, the lower the costs, the lower the car price, and the more sales.

Ideally car manufacturers could re-use major assemblies such as the vehicle platform in all their offerings. But although re-use of the vehicle platform can be possible in vehicles that have the same wheelbase, the vehicle platform is affected by changes in wheelbase and is therefore difficult or impossible to reuse for models with different wheelbases. In electric cars, batteries take up a substantial amount of space on the vehicle platform, so that the battery pack is also affected by wheelbase changes. In electric vehicles, then, a desirable alternative to re-use of the vehicle platform and the battery pack is to make the vehicle platform easily customizable to different wheelbases, and to also make battery packs that are easily changeable to match changes in the size of the vehicle platform.

### SUMMARY

Embodiments of an apparatus include a front section of a vehicle platform for an electric vehicle and a rear section of a vehicle platform for the electric vehicle. A panel joins a rear edge of the front section to the front edge of the rear section, and the length of the panel can be varied to change the wheelbase of the vehicle platform. A battery pack has a plurality of battery modules therein and can be coupled to a lower part the vehicle platform. The length of the battery pack and the arrangement of the battery modules inside the battery pack depend on the wheelbase of the vehicle platform.

Embodiments of a system include a vehicle platform for an electric vehicle. The platform includes a front section of a platform, a rear section of the vehicle platform, and a panel joining a rear edge of the front section to the front edge of the rear section. The length of the panel can be varied to change the wheelbase of the vehicle platform. A battery pack having a plurality of battery modules therein is coupled to a lower part the vehicle platform, and the length of the battery pack and the arrangement of the battery modules inside the battery pack depend on the wheelbase of the vehicle platform. A drivetrain is coupled to the lower part of the vehicle platform and a vehicle body is coupled to an upper part of the vehicle platform.

Embodiments of a process include joining a rear edge of a front section of a vehicle platform for an electric vehicle to a front edge of a rear section of a vehicle platform for the electric vehicle using a panel, changing the length of the panel to change the wheelbase of the vehicle platform; and adjusting the length of a battery pack coupled to a lower part the vehicle platform, and adjusting the arrangement of a plurality of battery modules inside the battery pack, to adapt to the wheelbase of the vehicle platform.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is an exploded view of an embodiment of an electric vehicle.

FIG. 2 is a perspective view of an assembled embodiment of a vehicle platform, power train, and battery pack for an electric vehicle.

FIG. 3 is a perspective view of an embodiment of a vehicle platform for an electric vehicle.

FIGS. 4-5 are simplified plan views of an embodiment of a vehicle platform for an electric vehicle.

FIGS. 6A-6C together illustrate an embodiment of a battery pack for an electric vehicle. FIG. 6A is a perspective view, FIG. 6B a plan view, and FIG. 6C a cross-sectional view taken substantially along section line C-C in FIG. 6B.

FIG. 7 is a pair of plan views of embodiments of the battery pack shown in FIGS. 6A-6C having different lengths.

FIGS. 8A-8C together illustrate an embodiment of a connection between a rear suspension subframe attached to the vehicle platform and an embodiment of a battery case. FIG. 8A is a perspective view, FIG. 8B an enlargement of the area circled on FIG. 8A, and FIG. 8C a cross-sectional view taken substantially along section line C-C in FIG. 8B.

### DETAILED DESCRIPTION

Embodiments are described of a vehicle platform for an electric vehicle. The platform's length can be changed to adjust the wheelbase of the platform. The platform includes a front section and a rear section that are joined by a panel. The panel is attached to the rear edge of the front section and to the front edge of the rear section, and the length of the panel can be changed to change the wheelbase of the platform. A battery pack can be mounted to the underside of the platform. The battery pack includes a battery case with a plurality of battery modules inside. The length of the battery case, and the arrangement of battery modules inside, can be changed to adjust to the changed wheelbase of the vehicle platform.

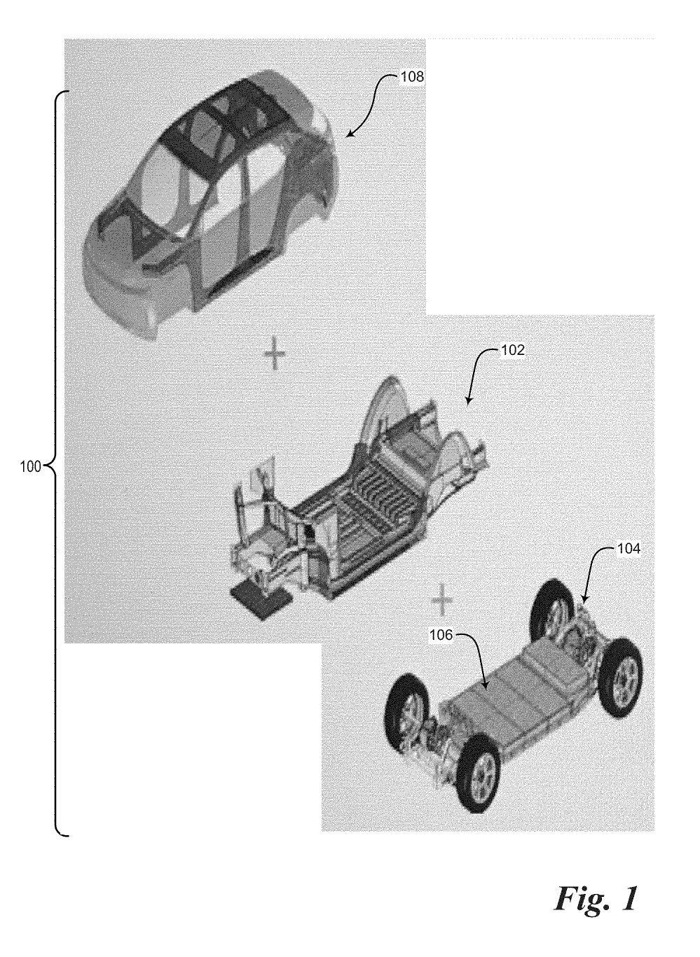

FIG. 1 illustrates an embodiment of an electric vehicle 100. Vehicle 100 includes a vehicle platform 102, a drivetrain 104 with a battery pack 106, and a body 108. In an assembled vehicle, platform 102 is placed on top of drivetrain 104 and battery pack 106—or, put differently, battery pack 106 and drivetrain 104 are inserted into the underside of vehicle platform 102. Vehicle body 108 is then fixed in position on top of vehicle platform 102.

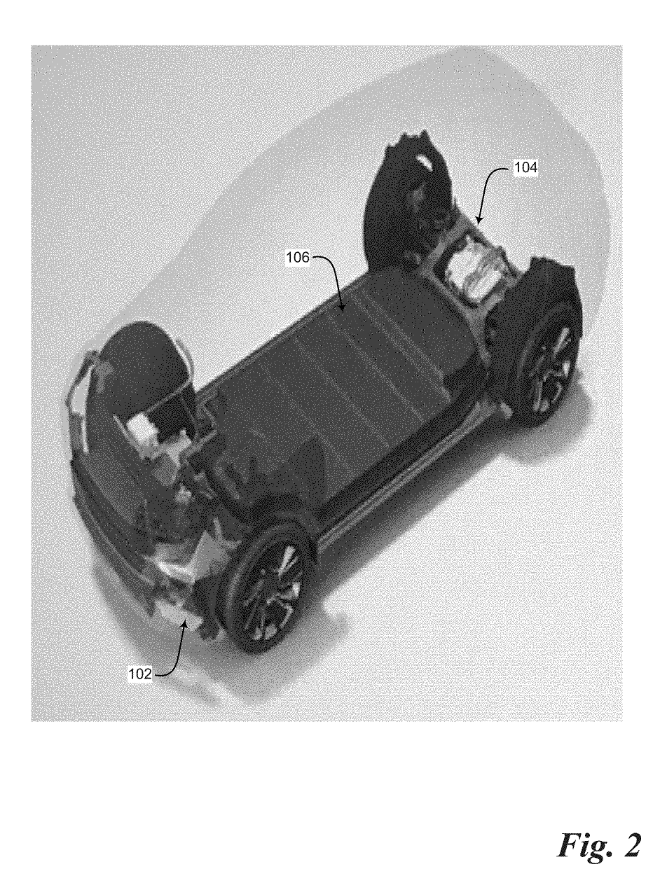

FIG. 2 illustrates a partially-assembled embodiment of electric vehicle 100, with drivetrain 104 and battery pack 106 in their operational positions within platform 102, battery pack 106 having been inserted through the bottom of platform 102 and bolted or otherwise fixed into position on the vehicle platform.

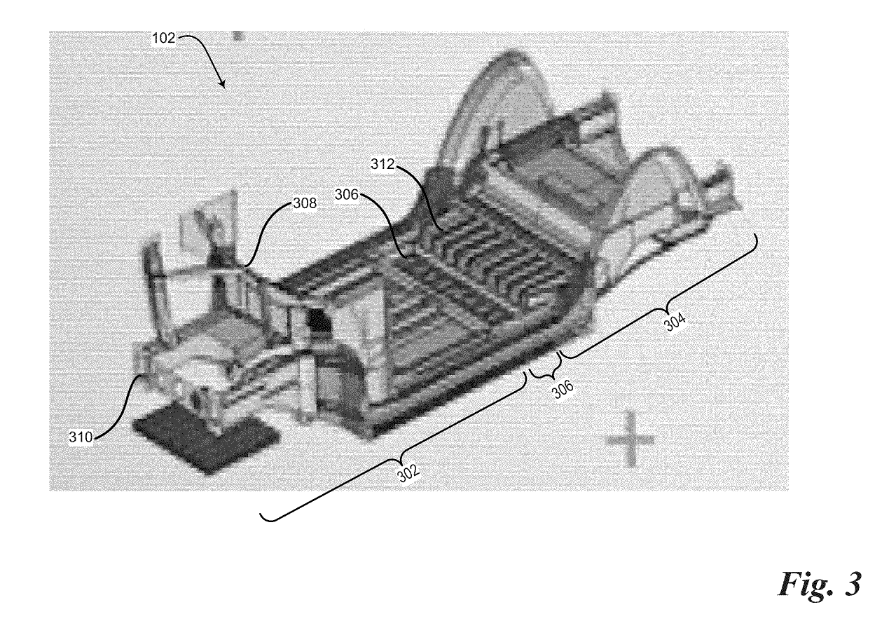

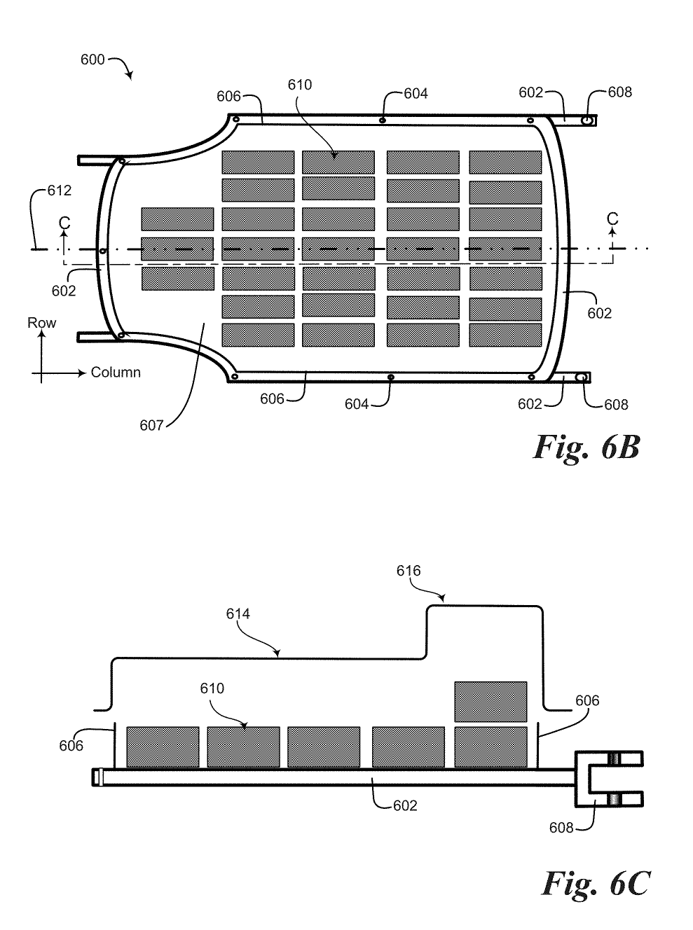

FIG. 3 illustrates in more detail an embodiment of vehicle platform 102. Vehicle platform 102 includes a front section 302 and a rear section 304. From section 302 includes structural provisions 310 for attaching front drivetrain components including wheels, front suspension, front differential, and axles (not shown). Similarly, rear section 304 includes structural provisions for attaching corresponding rear drivetrain components including wheels, rear wheels, rear suspension, rear axles, rear differential, etc. Front section 302 also includes a structure 308 to separate to the passenger cabin from the forward compartment and to provide for attaching body 108 to the vehicle platform. In the illustrated embodiment rear section 304 includes a raised section 312 designed to accommodate a correspondingly raised part of the battery pack (see FIGS. 6A and 6C). Raised section 312 can also be used as a base on which to mount the vehicle's rear passenger seats. A middle panel 306 joins front section 302 to rear section 304. In one embodiment of platform 102, panel 306 is positioned just forward of where the rear passenger seats would be, but in other embodiments panel 306 can be positioned elsewhere in the platform. The materials and design of middle panel 306 are chosen to ensure that panel 306 can carry the loads to which it will be subjected during operation.

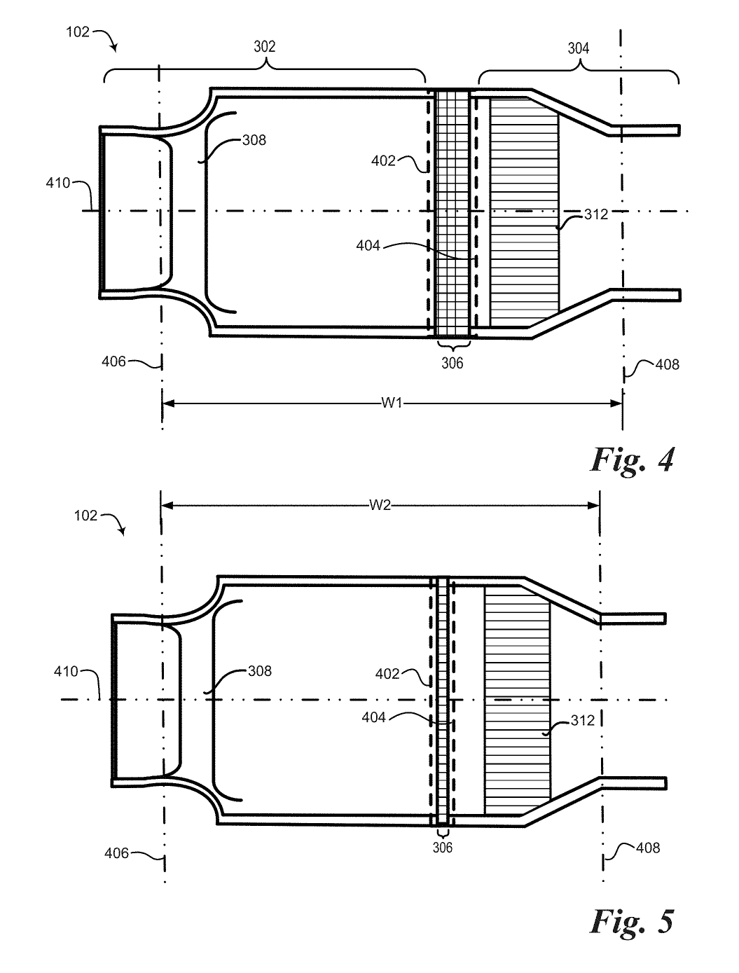

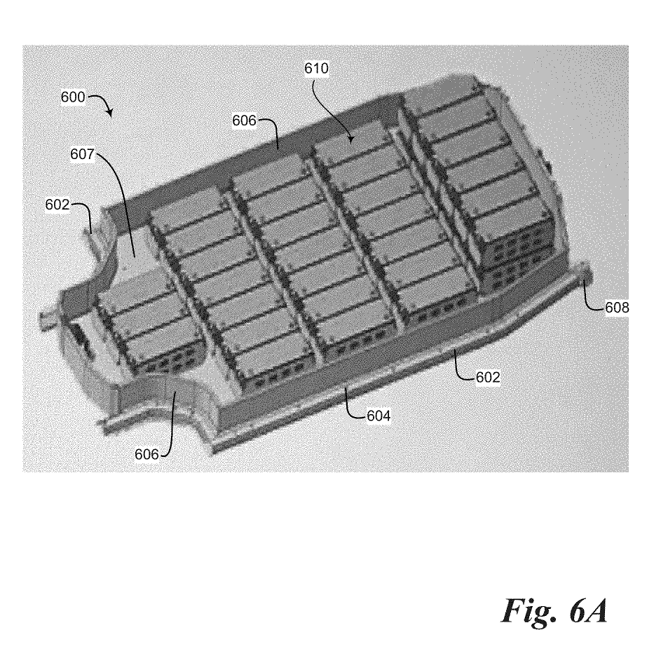

FIGS. 4-5 illustrate embodiments of vehicle platform 102 having different wheelbases—that is, different distances W, parallel to vehicle longitudinal axis 410, between the vehicle's front wheel axis 406 and the vehide's rear wheel axis 408. FIG. 4 illustrates an embodiment of platform 102 having a first wheelbase W1. In this embodiment, front section 302 and rear section 304 are again joined by panel 306. Panel 306 can be joined to the rear edge of front section 302, for example by welding along weld line 402 and, similarly, panel 306 can be joined to the front edge of rear section 304 by welding along a weld line 404. In other embodiments, of course, other methods can be used to join panel 306 to front sections 302 and rear section 304—fasteners, for instance.

FIG. 5 illustrates an embodiment of vehicle platform 102 having a second wheelbase W2 different than first wheelbase W1 in FIG. 4. In the illustrated embodiment W2 is shorter than W1, but in other embodiments W2 could be longer than W1. Different vehicle models often have different wheelbases, and that would usually require designing and building a new platform for each vehicle model. To avoid designing and building an entirely new vehicle platform for each model—and, of course, to avoid the associated expense—vehicle platform 102 can be easily lengthened or shortened to accommodate different wheelbases. In vehicle platform 102 this is accomplished by changing the length of panel 306—that is, its dimension parallel to vehicle longitudinal axis 410. In the embodiment of FIG. 5 panel 306 is shorter that in the embodiment of FIG. 4, leading to a wheelbase W2 that is shorter than wheelbase W1. All other parts of platform 102 can be left untouched, thus providing common attachment points for different bodies and drivetrains of different models. In one embodiment, panel 306 can be used to change the wheelbase of vehicle platform 102 by approximately 100-150 mm.

FIGS. 6A-6C together illustrate an embodiment of a battery pack 600 for electric vehicle 100. FIG. 6A is a perspective view, FIG. 6B a plan view, and FIG. 6C a cross-sectional view. Battery pack 600 includes a battery case with battery modules 610 inside. A rigid frame 602 surrounds and forms the perimeter of the battery case. Holes 604 allow rigid frame 602, and hence the entire battery pack, to be attached to the bottom of vehicle platform 102. A substantially planar high-strength rigid plate is fastened to rigid frame 602 to form the bottom 607 of the battery and, when the battery pack is installed on the vehicle, bottom 607 forms the bottom of the vehicle. Bottom 607 is made from a high-strength material so that battery modules 610 are protected from damage during operation of vehicle 100. A sidewall 606 that is substantially perpendicular to bottom 607 is also positioned around the perimeter of the battery case to form a sort of pan within which battery modules 610 can be placed. Attachment points 608 are devises formed at the rearmost extremity of rigid frame 602 to allow the battery case to be attached to the vehicle's rear suspension subframes, thus taking advantage of the battery case's structural strength to take up loads from other parts of vehicle 100.

A plurality of battery modules 610 are positioned on bottom 607 within the perimeter formed by sidewall 606. Battery models 610 are organized in rows and columns. As shown in FIG. 6B, in the illustrated embodiment the rows run perpendicular to battery pack axis 612, while the columns run parallel to axis 612. When the battery pack is installed in vehicle platform 102, battery pack axis 612 will substantially align with automobile axis 410. In the illustrated embodiment there are seven columns and five rows. Each column has four rows, except the three middle columns, which each have five rows. Put differently, each row has 7 columns except for the row closest to the front of the battery pack, which has only three columns (i.e., only three battery modules 610). In every row, the battery modules are rectangular and are positioned with their longest dimension aligned with axis 612.

FIG. 6C further illustrates the arrangement of battery modules 610 inside the battery case. In some embodiments, all the battery modules 610 need not be positioned directly on bottom 607, but some can instead be stacked on top of other battery modules. In the illustrated embodiment, the battery modules in the rearmost row form a stack two modules high, but in other embodiments with stacked battery modules the stacks can have three or more modules. In other embodiments, rows other than, or in addition to, the rearmost row can be stacked, and not every column within each row must be stacked. In still other embodiments there need be no battery module stacking at all. After all the necessary battery modules are positioned in the battery case, a lid 614 can be attached to rigid frame 602 around its perimeter for form a sealed enclosure for the battery modules. Where battery stacking is present, such as in the illustrated embodiment, lid 614 can include a part 616 shaped to accommodate the battery module stacking.

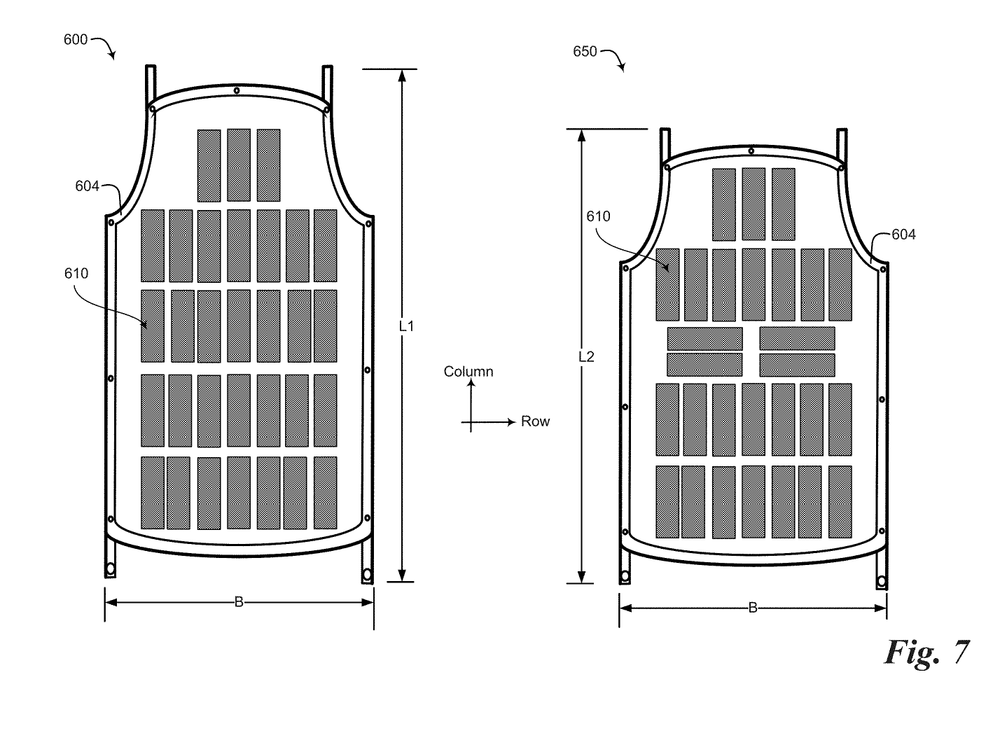

FIG. 7 illustrates embodiments of battery packs 600 and 650 having different lengths. Battery pack 600 fits into vehicle platform 102 between the front and rear wheels (see FIG. 2), so that when the wheelbase of platform 102 is changed by changing the length of panel 306 (see FIGS. 4-5), the length of battery pack 600 might need to change as well. Battery pack 600 is substantially the same battery pack illustrated in FIGS. 6A-6C and has width B, length L1, and battery modules 610 arranged as before. Battery pack 650 has the same width B but has a length L2 that is shorter than L1. As a result of its shorter length, battery pack 650 has a different number and arrangement of battery modules. In battery pack 650, the third row of battery modules 610 has three fewer batteries modules than the same row in battery pack 600. And in battery pack 650 the orientation of the rectangular battery modules in the third row has been changed to that the longest dimension of the battery modules is now perpendicular to the battery pack axis 612 instead of parallel to the axis as before. Other embodiments, however, need not use rectangular battery modules, and in those embodiments different module arrangements can be used.

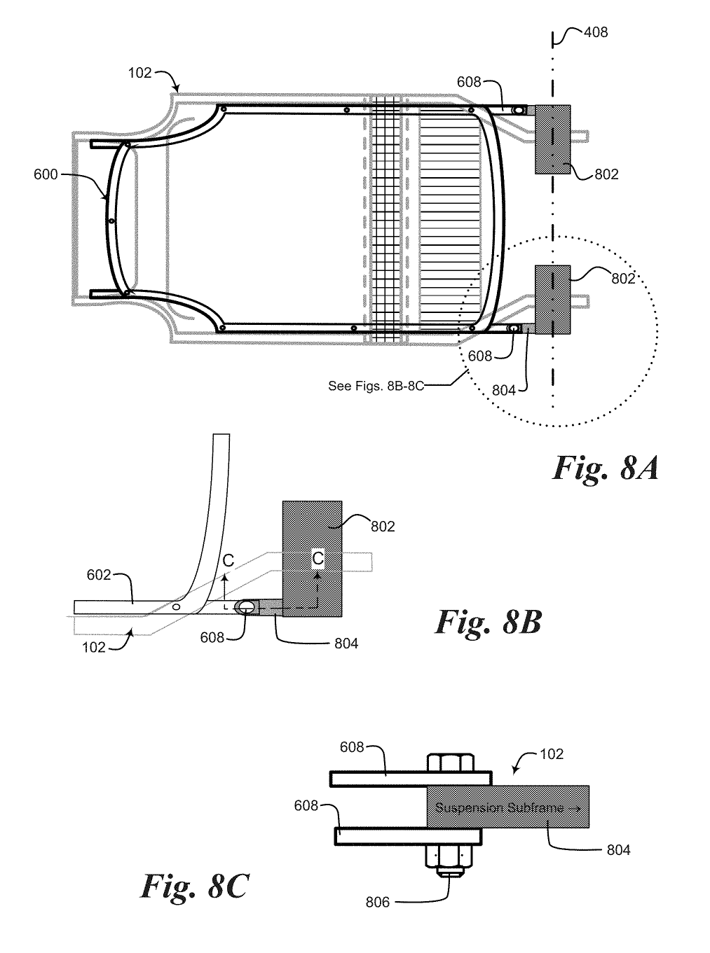

FIGS. 8A-8C schematically illustrate an embodiment of a battery pack being used as a structural member to carry loads from other components in vehicle 100. FIG. 8A is a plan view showing vehicle platform 102 (shown in grey lines) with battery pack 600 and rear suspension subframes 802 installed. As their names suggests, rear suspension subframes 802 are attached to platform 102, and then the vehicle's rear suspension is attached to the suspension subframe. As a result, the rear suspension subframes can be subjected to substantial loads. When battery pack 600 is installed, each clevis 608 projects from the rear of the battery pack to a position where they can be connected to tongues 804 that form part of the rear suspension subframes. By so doing, battery case 600 takes up some of the loads to which the rear suspension subframes are subjected.

FIGS. 8B-8C are plan-view and cross-sectional enlargements, respectively, of the region shown in a circle in FIG. 8A. Rear suspension subframe 802 is connected to vehicle platform 102 and has a tongue or other member 804 that projects toward the front of the vehicle. Tongue 804 is dimensioned such that it extends between the forked tabs that form clevis 806. A bolt 806 is inserted through both forked tabs of clevis 806 and through tongue 804 to keep the tongue secured in the clevis and thus transfer loads from the tongue through the clevis to battery case 602. The use of a clevis results in a double-shear connection between rear suspension subframe 802 and battery pack 804, meaning that bolt 806 carries shear loads at the two locations where tongue 804 interfaces with the tabs of clevis 608.

The above description of embodiments, including what is described in the abstract, is not intended to be exhaustive or to limit the invention to the described forms. Specific embodiments of, and examples for, the invention are described herein for illustrative purposes, but various equivalent modifications are possible within the scope of the invention in light of the above detailed description, as those skilled in the relevant art will recognize.

What is claimed is:

1. An apparatus comprising:
a front section of a vehicle platform for an electric vehicle;
a rear section of a vehicle platform for the electric vehicle;
a panel joining a rear edge of the front section to the front edge of the rear section, wherein the length of the panel can be varied to change the wheelbase of the vehicle platform; and
a battery pack having a plurality of battery modules therein, the battery pack being coupled to a lower part the vehicle platform, wherein the length of the battery pack and the arrangement of the battery modules inside the battery pack depend on the wheelbase of the vehicle platform.

2. The apparatus of claim 1 wherein the battery pack includes a battery cases comprising:
a rigid frame forming a pan within which the plurality of battery modules are positioned; and
a lid whose perimeter can be coupled to the rigid frame.

3. The apparatus of claim 2 wherein the battery case is load-bearing.

4. The apparatus of claim 2 wherein the rigid frame of the battery case is attached to an underside of the vehicle platform.

5. The apparatus of claim 2, further comprising a pair of suspension subframes coupled to the rear section of the vehicle platform and coupled to a rear part of the rigid frame of the battery case.

6. The apparatus of claim 5 wherein the suspension subframe is coupled to the rear of the battery case by a double-shear connection.

7. The apparatus of claim 1 wherein the battery case can have a first length or a second length, the second length being shorter than the first length.

8. The apparatus of claim 7 wherein the battery case having the first length has a plurality of rectangular battery modules arranged in rows with their longest dimension aligned with a longitudinal axis of the car.

9. The apparatus of claim 7 wherein the battery case having the second length has a plurality of rectangular battery modules, some of the plurality arranged in rows with their longest dimension aligned with the longitudinal axis of the car and some of the plurality with their longest dimension aligned perpendicular to the longitudinal axis of the car.

10. A system comprising:
a vehicle platform for an electric vehicle, the platform including:
a front section of a platform, a rear section of the vehicle platform, and a panel joining a rear edge of the front section to the front edge of the rear section, wherein the length of the panel can be varied to change the wheelbase of the vehicle platform;
a battery pack having a plurality of battery modules therein, the battery pack being coupled to a lower part the vehicle platform, wherein the length of the battery pack and the arrangement of the battery modules inside the battery pack depend on the wheelbase of the vehicle platform;
a drivetrain coupled to the lower part of the vehicle platform;
a vehicle body coupled to an upper part of the vehicle platform.

11. The system of claim 10 wherein the battery pack includes a battery cases comprising:
a rigid frame forming a pan within which the plurality of battery modules are positioned; and
a lid whose perimeter can be coupled to the rigid frame.

12. The system of claim 11 wherein the battery case is load-bearing.

13. The system of claim 11 wherein the rigid frame of the battery case is attached to an underside of the vehicle platform.

14. The system of claim 11, further comprising a pair of suspension subframes coupled to the rear section of the vehicle platform and coupled to a rear part of the rigid frame of the battery case.

15. The system of claim 14 wherein the suspension subframe is coupled to the rear of the battery case by a double-shear connection.

16. The system of claim 10 wherein the battery case can have a first length or a second length, the second length being shorter than the first length.

17. The system of claim 16 wherein the battery case having the first length has a plurality of rectangular battery modules arranged in rows with their longest dimension aligned with a longitudinal axis of the car.

18. The system of claim 16 wherein the battery case having the second length has a plurality of rectangular battery modules, some of the plurality arranged in rows with their longest dimension aligned with the longitudinal axis of the car and some of the plurality with their longest dimension aligned perpendicular to the longitudinal axis of the car.

19. A process comprising:
joining a rear edge of a front section of a vehicle platform for an electric vehicle to a front edge of a rear section of a vehicle platform for the electric vehicle using a panel;
changing the length of the panel to change the wheelbase of the vehicle platform; and
adjusting the length of a battery pack coupled to a lower part the vehicle platform, and adjusting the arrangement of a plurality of battery modules inside the battery pack, to adapt to the wheelbase of the vehicle platform.

20. The process of claim 19 wherein the battery pack includes a battery cases comprising:
a rigid frame forming a pan within which the plurality of battery modules are positioned; and
a lid whose perimeter can be coupled to the rigid frame.

21. The process of claim 20 wherein the battery case is load-bearing.

22. The process of claim 20 wherein the rigid frame of the battery case is attached to an underside of the vehicle platform.

23. The process of claim 20, further comprising coupling a pair of suspension subframes to the rear section of the vehicle platform and to a rear part of the rigid frame of the battery case.

24. The process of claim 23 wherein the suspension subframe is coupled to the rear of the battery case by a double-shear connection.

25. The process of claim 19 wherein the battery case can have a first length or a second length, the second length being shorter than the first length.

26. The process of claim 25 wherein the battery case having the first length has a plurality of rectangular battery modules arranged in rows with their longest dimension aligned with a longitudinal axis of the car.

27. The process of claim 25 wherein the battery case having the second length has a plurality of rectangular battery modules, some of the plurality arranged in rows with their longest dimension aligned with the longitudinal axis of the car and some of the plurality with their longest dimension aligned perpendicular to the longitudinal axis of the car.
